(19) United States
(12) Patent Application Publication
(10) Pub. No.: US 2010/0313439 A1
(43) Pub. Date: Dec. 16, 2010

(54) Method and Plant for Producing Biomass for Energy Production

(76) Inventor: Ole Bjørn KLEVEN, Geilo (NO)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/797,895

(22) Filed: Jun. 10, 2010

Related U.S. Application Data
(60) Provisional application No. 61/268,269, filed on Jun. 10, 2009.

(51) Int. Cl. F26B 3/10; A01G 23/08

(52) U.S. Cl. 34/361; 144/337; 144/34.1; 34/581

(57) ABSTRACT

A method and system are provided for taking out or culling, transporting and drying of culled or removed wood from a forest, where the wood is ground or cut into small fragments or units, such as chips, powder, or the like, and then transported out of the forest to a collecting and/or processing site. The ground or fragmented wood is transported over long distances, out from the forest, to a remotely placed collecting and/or processing site. The ground or fragmented wood being transported by a flow of air, and wherein the flow of air transporting the fragmented units is supplied with energy to secure reduction of the water content of the fragmented units during the transport.

### RELATED APPLICATIONS

This application claims priority from U.S. Provisional Patent application Ser. No. 61/268,269 which was filed on Jun. 10, 2009, the content of which is incorporated by reference.

### BACKGROUND OF THE INVENTION

1. Technical Field of the Invention

The present invention relates to a method and a plant for producing biomass taken out, cut, transported and dried from a forest. The raw material for the biomass is in the form wood which is chipped or cut into small units, such as chips, powder, or the like, and then transported out of the forest to a collecting plant and/or processing plant for further processing.

2. Discussion of Related Art

From an environmental point of view it is important to find energy sources which are sustainable and which are more or less carbon neutral or at least as carbon neutral as possible. Use of biomass is such energy source. The most commonly raw material used for such biomass is saw dust, shavings, and chips, by-products of ordinary forest lumber industry.

Further, it has previously been proposed to use timber and wood taken out of the forest as direct raw material for production of pellets, such pellets being produced from chipped timber, chipped at a processing plant at a remote distance from the forest.

It has also been proposed to use green wood and wood waste as raw material, requiring the need of drying prior to conversion into heat energy. Such type of raw materials requires, however, extensive drying prior to conversion into heat energy.

Large areas of forest have recently dried out and died due to detrimental weather conditions and attacks of insects, such as bark beetles. Such vast volumes of dead trees represent thus an important challenge, since the quality of such wood is not suitable for use as raw material for pulp or wood works. Such type of timber may, however, be an important fuel source for generating energy, since the dry wood does no require extensive drying prior to formation of pellets.

It has previously been proposed to use pneumatic means for picking up and conveying particulate material from a site and transport such particulate material by means of pneumatic to a transport vehicle for further transport.

U.S. Pat. No. 4,973,203 describes a pick-up assembly for grain and other particulate material, including a pick-up head with an elongated narrow rectangular forward facing opening, a tubular for discharge conduit extending rearward from the pick-up head and pneumatic grain conveyor associated with the tubular.

U.S. Pat. No. 3,876,260 disclose a mechanical system for retrieving solid particulate material from a defined area which includes carriage guide rail means adjacent the defined area, the carriage means being adapted to transverse the carriage guide rails means, and pneumatic sweeper means mounted on the carriage means and adapted to sweep up particulate material in a sweep path that transverses the width of the defined area.

It should be appreciated, however, that the prior art solutions specified above are designed for used in specifically adapted urban areas with an already available infrastructure and/or leveled surfaces.

A challenge associated with taking out and/or culling of such type of timber is that the dead trees in many instances are found in very remote areas without any infrastructure in the form of roads or railways or the like, and in a terrain that is more or less inaccessible for motor vehicles of a certain size. Further, the terrain is very hilled or at least hillocky.

Further, another challenge is to provide a take out which is cost optimal, resulting in an end product in the form of pellets or the like which is competitive with fossil and non-renewal products such as hydrocarbons and which meet the environmental requirements.

Yet another challenge associated with the use of such dead dry wood is the need of further drying process, requiring long time storage in more or less sheltered areas, depending on the sun and wind for the drying process, or depending on heat for obtaining the required dryness of the wood.

Yet another challenge is to arrive at a sustainable forestry providing forest regeneration, future growth and development of remaining trees, involving careful blending of biology and ecology of the forest.

There is also a requirement of more cost effective and gentle way of transporting out the wood or lumber out of the forest, using the entire tree, including at least the branches, as a raw material.

### SUMMARY OF THE INVENTION

An object of the present invention is to secure culling and take out of trees from a remote forest in such manner that the impact on the ground and the environment is as small as possible, without having to construct new roads or strengthen the existing roads for access to the relevant part of the forest.

Another object of the present invention is to provide a system which contributes to the drying of the wood culled or taken out during transport to a collecting and/or processing plant.

A still further object of the invention is to provide a system which is as light as possible and which is easily transportable in terrain of varying character.

Another object of the present invention is to provide a system where as little and light machinery as possible is required up front in the forest where the take out or culling is performed.

Yet another object of the invention is to provide a method for producing energy which avoids appearance of methane which otherwise would be produced if the wood is allowed to rotten.

Yet another object of the invention is to provide a method and means which is not dependent upon transporting fuel in trucks or the like into the forest to the logging site.

According to the present invention the objects are achieved by a system and a method as further defined in the independent claims.

The fragmented units may be conveyed over long distances out of the forest, such as at least 500 meters or more, to the remotely placed collecting and/or processing site, the fragmented units being transported by means of a flow of air, and wherein the flow of air transporting the fragmented units during the conveyance also is supplied with energy to secure reduction of the water content of the fragmented units during the transport.

According to one embodiment of the method, the flow of air is supplied with thermal energy for further drying of the fragmented units.

The flow of air may for example be produced by a vacuum produced at the remote collecting and/or processing site.

It should be appreciated that the fragmented units may be transported through a provisionally installed flexible duct or hose extending continuously between the take out site in the forest over a distance of two to three kilometer and the collecting and/or processing site. The thermal energy supplied may preferably, but not necessary, be provided by surplus energy form the fragmenting unit at the take out or culling site.

The system for take out or culling, transport and drying of culled or taken out wood from a forest, comprises a unit for fragmenting lumber or trees, for example by grinding or chipping, cutting the lumber or the trees into small fragments or units, such as chips, powder, or the like, at the take out site and transporting means for conveying the fragmented lumber or units out of the forest to a collecting and/or processing site, the fragmented units being transported over long distances to a remotely placed collecting and/or processing site. The fragmented units are conveyed through a flexible and moveable duct or hose by means of a flow of air, the flow of air transporting the fragmented units also contributing to reduction of the water content in the fragmented units during the transport through the duct or hose.

Said duct or hose may preferably extend continuously between the take out site in the forest and collecting and/or processing site, and according to one embodiment the system may also comprise means for supply of thermal energy, enhancing the drying effect during said transporting phase.

According to a further embodiment the length of the duct or hose is at least 500 meters, preferably at least 2000-2500 metres. Further, the system may preferably be movable at least at the take out side so as to obtain as much efficiency and flexibility as possible at the take out site, covering as large area as possible.

According to the present invention, it will be possible to exploit the entire tree, including top of the tree, bark, branches and fur or blades, thus avoiding residual material otherwise present as a result of conventional logging and forestry, and which otherwise would have produce detrimental and uncontrolled discharge of methane into the atmosphere as a consequence of the decaying process.

Yet another advantage is that it is not required with road constructions or deployment of heavy equipment, machinery or vehicles into the forest. The system according to the invention is also very gentle with respect to the forest surface, enabling a gentle take out of lumber and at the same time enabling take out from remote areas of dead trees.

Yet another advantage is that the wood may be dried during the transport from the drawn or take out area to the collecting and/or processing site.

According to the present invention it may be possible to produce energy at a lower cost that for use of fossil fuel, such as coal, oil or petrol. The energy produced based on pellets produced in this way will be carbon neutral and will be a complete or in part substitution of fossil fuel.

According to calculation made, it may be possible to transport 10 tonnes chips per hour over a distance of 1.4 kilometres. Further, another major advantage resides in that all machines and units/equipment exist as more or less standard commodities in the marked.

By depending of a suction in order to provide the transport of the chips the need of a separate, tailor made mouth piece at the logging end is eliminated. It should also be appreciated that it is much simpler to introduce chips into the duct by means of suction than having to “force” such chips into the duct in case of establishing a blowing effect at the logging site. Also, the risk of causing a blockage in the duct depending on suction is substantially reduced compared to depending upon blowing the chips through the duct.

Yet another object of the invention is to provide a duct or hose which is able to withstand the effect of suction without more or less completely loosing its shape, and still being able to be winded onto a reel with as small volume as possible.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following, an embodiment of the present invention shall be described in further details, referring to the accompanying drawings, where:

FIG. 1 shows schematically a view of a plant according to the present invention; and

FIG. 2 shows schematically a vertical section through an alternative embodiment of a duct or hose according to the invention.

### DETAILED DESCRIPTION OF THE PRESENTLY PREFERRED EMBODIMENTS

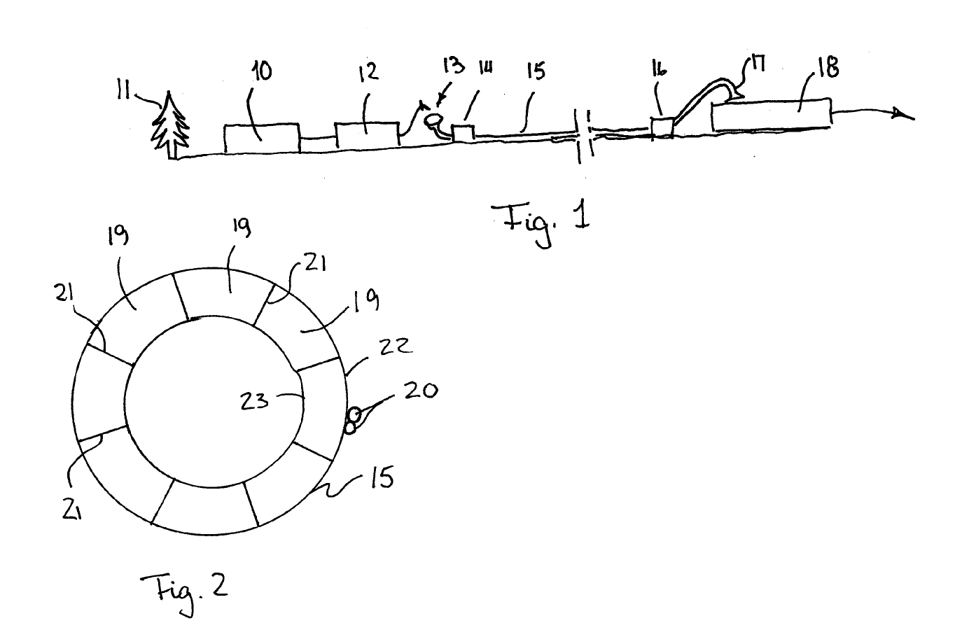

FIG. 1 shows schematically a view of a flow sheet for a system according to the present invention for taking out and/or culling of trees 11 from a forest. The present invention may preferably form auxiliary equipment, arranged on a light logging and/or processing vehicle which in a simple manner may operate in hilly or hillocky forest terrain with trees 11 to be taken out. The system comprises a unit 10 for cutting a tree 11 at its extreme lower end and transported said tree 11 including bark, branches and leaves or fur to a chipping or grinding machine 12, transferring said entire tree 11 into chips or powder. From the chipping or grinding machine 12 the chips or the powder is conveyed to and through a conveying means 15 for example in the form of a duct or a hose for further transport base on a pressure differential between the inlet end and the outlet end of said duct or hose to a collecting and/or processing site 18. The conveying means 15 may preferably have a substantial length, for example more than 100 meters and preferably more than 1400 metres or more. Further, it should be appreciated that the conveying means 15 preferably may be flexible, for example made of a plastic material such as polyethylene. A flow of air is used for conveying the chips or powder through the conveying means 15. The flow of air may be achieved by means of a fan arranged at the collecting and/or processing site 18, sucking the chips or powder above a critical velocity through the conveying means.

Since a fan is used at the receiving, collecting and/or processing site 18, producing a suction through the duct 15, it is a requirement that the duct 15 must be form stable, i.e. have a inherent property of not collapsing when subjected to such suction at the site 18.

As a consequence of the air transportation through the conveying means 15 a drying effect on the chips or the powder is obtained. Such drying effect may be enhanced by also introducing thermal energy at the inlet of the conveying means 15. Such thermal energy may for example be surplus energy or heat delivered by the chipping or powdering machine 12 and/or heat energy delivered by the cutting tree means 10. Optionally a separate heater (not shown), for example powered by fossil fuel, may also be installed on the chipping or grinding machinery 12.

At the collecting and/or processing site a receiving container 18 may be arranged, collecting and storing received chips and/or wooden powder. Such receiving and/or storage container 18 may be associated with a compressing means providing a large compressive force crushing the cell wall structures of cells of the wood, compressing the chips and/or powder into pellets.

According to an alternative embodiment of the invention, also the compressing unit producing pellets may be arranged in conjunction with the chipping and/or grinding machine 12 upstream in the system. In such instance the pellets are blown or sucked through the hose 15. It should also be appreciated that instead of or in addition to depending on establishing a air flow based on vacuum, a compressor may be used such compressor being arranged in conjunction with the chipping or grounding machine 12, upstream of the hose, thereby causing the required air flow.

In case dead trees 11 are used as raw material, the degree of drying will be limited, since the dead trees 11 are more or less dried in situ prior to the cutting.

The drying effect provided by conveying the chips 1.5 km by an air flow through the hose 15 will cause 12%-point reduction of the water content in the chips. This may be beneficial since the wood to be used for the production of pellets must have a water content of 15% or less. Dead trees may have an inherent water content of 21%-25%.

According to an embodiment of the invention, ducts, pipelines, cables or umbilicals 20 may be associated with the duct 15, providing energy such as diesel fuel, electricity or hydraulics from the collecting and/or processing site 18 to the logging and/or processing vehicle at the opposite end. Further, the umbilical may also be used for control signals, communication or the like.

Said additional ducts, pipelines, cables and/or umbilical 20 may be arranged in a piggy-back configuration outside or inside the duct 15. Alternatively, said ducts, pipelines, cables and/or umbilical form an integral part of the duct wall.

In order to obtain a for form stable duct 15, able to withstand internal suction, the duct 15 may for example be doubled walled, i.e. an inner wall 23 and an outer wall 22, the space between said inner and outer walls 22,23 being filled with compressed air. A cross section through such embodiment of the duct or hose 15 is shown in FIG. 2. The hose 15 is for such purpose divided into several compartments 19, separated by dividing walls 21. Alternatively or in addition, the duct wall may contain helical reinforcements for example made of steel cords. In its most simple form the hose 15 is made of a single, form stable wall.

Further, it should be appreciated that said duct may be provided with one or more inspections opening along the length of the duct 15.

As indicated in FIG. 1, a thermal energy producing means 14 may be arranged at the inlet part of the hose 15, supplying heat in order to enhance drying of the chips during the chip transport through the hose 15.

According to an optional embodiment of the invention, the inner wall 23 may at sections being provided with one way valves, allowing compressed air to be blown into the inner duct in order to enhance the transport of the chips through the hose 15.

Compressed air for the compartments 19 may be supplied at the receiving end 18, the far end of the compartments being closed so that compressed air is not allowed to escape from the compartments 19 in an uncontrolled manner.

When the transport is completed and the hose is to be partly or completely moved to another site, the compressed air in the compartments 19 is discharged, enabling the volume of the hose to be reduced and allowing the hose 15 to be winded on to a reel in a collapsed, flat manner.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. The method for taking out or culling, transport and drying of culled or taken out wood from a forest, where the wood is grinded or cut into small fragments or units, such as chips, powder, or the like, and then transported out of the forest to a collecting and/or processing site, wherein the fragmented units are transported over long distances, out from the forest, to the remotely placed collecting and/or processing site, the fragmented units being transported by means of a flow of air, and wherein the flow of air transporting the fragmented units also is supplied with energy to secure reduction of the water content of the fragmented units during the transport.

2. The method according to claim 1, wherein the flow of air is supplied with thermal energy for further drying of the fragmented units.

3. The method according to claim 1, wherein the flow of air is produced by providing a vacuum or a suction at the remote collecting and/or processing site.

4. The method according to claim 1, wherein the fragmented units are transported through a provisionally installed flexible duct or hose extending continuously between the take out site in the forest over a distance of two to three kilometer and the collecting and/or processing site.

5. The method according to claim 1, wherein the thermal energy supplied is provided by surplus energy form the fragmenting unit at the take out or culling site.

6. The method according to claim 1, wherein fuel, electricity, control signals or the like are transferred from the collecting site to the logging site through lines associated with the duct.

7. A system for take out or culling, transport and drying of culled or taken out wood from a forest, comprising a unit for fragmenting lumber or trees, for example by grinded or chipping, cutting the lumber or the trees into small fragments or units, such as chips, powder, or the like, and then transporting means for conveying the fragmented lumber or units out of the forest to a collecting and/or processing site, the fragmented units being transported over long distances to a remotely placed collecting and/or processing site, the fragmented units being conveyed through a flexible duct or hose by means of a flow of air, and wherein the flow of air transporting the fragmented units also contribute to reduction of the water content in the fragmented units during the transport.

8. The system according to claim 7, wherein said duct or hose extending continuously between the take out site in the forest and collecting and/or processing site.

9. The system according to claim 7, wherein the system comprises means for supply of thermal energy for enhancing the drying effect during the conveying phase.

10. The system according to claim 7, wherein the length of the duct or hose is at least 500 meters.

11. The system according to claim 7, wherein the system is movable at least at the take out side.

12. The system according to claim 7, wherein the duct is form stable, i.e. being able to withstand an internal vacuum or suction without to any reasonable degree loosing its shape.

13. The system according to claim 7, wherein lines for supplying energy or control signals from the collecting site to the logging side form an integral part of the duct.
